(19) United States
(12) Patent Application Publication
(10) Pub. No.: US 2009/0292032 A1
(43) Pub. Date: Nov. 26, 2009

(54) Fire retardant foam and methods of use

(76) Inventors: Laxmi C. Gupta, Los Alamitos, CA (US); Ashish Dhuldhoya, Chino Hills, CA (US); Hemant Prajapati, Fullerton, CA (US); Utkarsh Varshney, Buena Park, CA (US); Joseph Jibrail, Frisco, TX (US)

Correspondence Address: KAGAN BINDER, PLLC, SUITE 200, MAPLE ISLAND BUILDING, 221 MAIN STREET NORTH, STILLWATER, MN, 55082, US

(21) Appl. No.: 12/387,470

(22) Filed: May 1, 2009

Related U.S. Application Data
(60) Provisional application No. 61/126,335, filed on May 2, 2008.

(51) Int. Cl. C08J 9/228

(52) U.S. Cl. 521/85

(57) ABSTRACT

Fire retardant foam systems comprise a first part comprising at least one ingredient having NCO functionality; and a second part comprising at least one ingredient having an active hydrogen functionality that is co-reactive with the NCO, wherein the first part and the second part are formulated so that when the parts are mixed together they form a cured foam. The foam system comprises a first fire retardant ingredient that is a phosphorus-based compound, a second fire retardant ingredient that is an intumescent material, and a third fire retardant ingredient that is a brominated ingredient additionally having an active hydrogen functionality that is co-reactive with the NCO of the first part.

Methods preparing a fire retardant foam comprise providing a fire retardant foam system as described above and mixing the first part and the second part together so that they form a cured foam. The foam made by this process and methods of protecting structures using the present foam system are also provided.

This application claims the benefit of U.S. Provisional Application Ser. No. 61/126,335 filed on May 2, 2008, entitled “FIRE RETARDANT FOAM AND METHODS OF USE,” which application is incorporated herein by reference in its entirety.

### FIELD OF INVENTION

The present invention relates to fire retardant systems and related methods and uses of such fire retardant systems.

### BACKGROUND OF THE INVENTION

Foam materials have been imparted with fire or flame retardant properties for some time by incorporation of fire retardant additives. For example, polyurethane foams were described in U.S. Pat. No. 4,363,882, which achieved the indicated flame retardancy by formulation using dibromoneopentyl glycol and a plasticizer that is either a halogenated phosphonate or halogenated phosphate ester.

Polyurethane foams can be prepared by reacting an isocyanate with polyols in the presence of a blowing agent to form a polyurethane polymer or a prepolymer. Such systems are often described in a very general sense as comprising a fire retardant, often only listing them with other components “such as catalysts, surfactants, and fire retardants.” See, e.g. U.S. Pat. No. 6,894,083.

Fire retardants are well-known and are typically added to and/or applied as a surface treatment to help prevent the spread of fire and/or protect a material exposed to fire. Commercially available fire retardants may be obtained in great variety, including examples such as bromine-based fire retardants, phosphorous-based fire retardants (e.g., ammonium polyphosphate (APP)), nitrogen-based fire retardants (e.g., melamine), inorganic-based fire retardants, and chlorine-based fire retardants.

A fire retardant can also be classified by the mechanism in which it acts as a fire retardant. For example, a class of fire retardants acts by absorbing heat, thereby cooling the surrounding material. Examples of cooling fire retardant materials are aluminum hydroxide and magnesium hydroxide. Another class of fire retardant material operates by release of gas that interferes with the flame. Examples of this class are the halogens, such as bromine and chlorine.

Another class of fire retardants use the mechanism known as “intumescence,” and is attributable to the fire retardant category known as “intumescents.” Intumescent fire retardants expand and form a char layer as a barrier between the underlying material and surrounding environment. This char layer is hard to burn, and insulates and protects the underlining material from burning. Intumescents operate by expansion either as a result of a chemical reaction under heat, or as by a primarily physical reaction that occurs due to the configuration of components in the intumescent material. Examples of chemical intumescents include phosphate-based materials and silica gel/potassium carbonate mixtures. Examples of physical intumescents include expandable graphite.

### SUMMARY OF THE INVENTION

The present invention provides a fire retardant foam system comprising:

a. a first part comprising at least one ingredient having NCO functionality; and

b. a second part comprising at least one ingredient having an active hydrogen functionality that is co-reactive with the NCO; wherein the first part and the second part are formulated so that when the parts are mixed together they form a cured foam.

The foam system comprises at least three fire retardant ingredients that are:

i) a first fire retardant ingredient that is a phosphorus-based compound,

ii) a second fire retardant ingredient that is an intumescent material; and

iii) a third fire retardant ingredient that is a brominated ingredient additionally having an active hydrogen functionality that is co-reactive with the NCO of the first part.

In a preferred embodiment, the first fire retardant ingredient is a phosphate-based compound.

Also provided are methods preparing a fire retardant foam comprising providing a fire retardant foam system as described above and mixing the first part and the second part together so that they form a cured foam. The foam made by this process is also provided. Methods of protecting structures using the present foam system are also provided.

The present system, methods and foams advantageously provide effective fire retardancy in a product that is easy to prepare and apply to a structure in need of protection. The present system provides surprising performance that is attributable in part to the structure of the material, because foam affords a unique loft that appears to help maintain char at critical locations, thereby structurally assisting in interference with propagation of flame. Further, it has surprisingly been observed that there is an apparent synergistic effect in combination of the at least three fire retardant ingredients that are the first fire retardant ingredient that is a phosphorous-based compound, the second fire retardant ingredient that is an intumescent material and the third fire retardant ingredient that is a brominated ingredient. In an embodiment of the present invention, the brominated fire retardant ingredient is a brominated compound having an active hydrogen functionality that is co-reactive with the NCO of the first part. In another embodiment, the brominated fire retardant ingredient is a brominated compound having a functionality that is co-reactive with the active hydrogen of the second part.

Additionally, because the fire retardant system is in the form of a foam the resulting foam when in place on a structure further provides the benefits of providing cushioning, thermally insulative and/or electrically insulative layer on or surrounding a material or device to be so protected.

In an aspect of the present invention, the present fire retardant foam can provide unique protection of building infrastructure through targeted protection of structural components and spaces to be protected from fire. In particular, critical support structures of buildings can be protected by provision of the present foam to the structure in a thickness and in an amount sufficient to afford protection of the structure from fire. In a preferred example of the present invention, the inventive foam is provided in the form of foam sheets in size, shape and density in the manner of conventional roofing foam insulation sheets. Such inventive insulation sheets provide the advantage of insulation in a convenient format useful in the construction industry and also provide excellent fire protection. As a result of the performance of the present fire retardant foam, critical damage to structures can be delayed or avoided, potentially saving lives and property from complete destruction from aggressive fire and/or blast damage. This level of protection was not previously achievable through conventional fire retardant usages. An additional embodiment of the present invention provides fire retardant foam packing materials. Thus, critical parts that are stored or in transit may be protected from fire damage.

Because the present fire retardant foam is prepared from a foam polymeric matrix, the resulting material has superior fire retardant performance as compared to other fire retardant systems.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is a photo of a comparative sample during a burn test.

FIG. 2 is a photo of a comparative sample after completion of a burn test.

FIG. 3 is a photo of a sample during a burn test.

FIG. 4 is a photo of a sample after completion of a burn test.

FIG. 5 is a photo of a sample during a burn test.

FIG. 6 is a photo of a sample after completion of a burn test.

FIG. 7 is a photo of a sample during a burn test.

FIG. 8 is a photo of a sample after completion of a burn test.

FIG. 9 is a photo of a sample during a burn test.

FIG. 10 is a photo of a sample after completion of a burn test.

FIG. 11 is a photo of a sample during a burn test.

FIG. 12 is a photo of a sample after completion of a burn test.

### DETAILED DESCRIPTION OF PRESENTLY PREFERRED EMBODIMENTS

The embodiments of the present invention described below are not intended to be exhaustive or to limit the invention to the precise forms disclosed in the following detailed description. Rather a purpose of the embodiments chosen and described is so that the appreciation and understanding by others skilled in the art of the principles and practices of the present invention can be facilitated.

The first fire retardant ingredient is a phosphorus-based compound. In a preferred embodiment, the first fire retardant ingredient is a phosphate-based compound. Particularly preferred ingredients that are phosphate-based compounds are tris(2,3-dibromopropyl)phosphate and other phosphate esters and the polyphosphates, preferably ammonium polyphosphate (“APP”). APP and methods of making APP are well known as described in, e.g., U.S. Pat. Nos. 5,165,904 (Staffel et al.), 5,277,887 (Staffel et al.), and 5,213,783 (Fukumura et al.), the disclosures of which are incorporated herein by reference.

The phosphorus-based fire retardant ingredient optionally can be pre-encapsulated, and preferably is encapsulated with an encapsulation material that additionally functions in support of fire retardancy. Examples of functional encapsulation materials include charring agents such as starch, dextrin, sorbitol pentaerythritol, phenol-formaldehyde resins or methylol melamine encapsulation materials, or the like. Particularly preferred fire retardant components include coated APP, which is well known as described in, e.g., U.S. Pat. Nos. 6,291,068 (Wang et al.), 5,599,626 (Fukumura et al.), and 5,534,291 (Fukumura et al.), the disclosures of which are incorporated herein by reference. A preferred melamine coated, APP fire retardant component for use in the present invention is commercially available from JLS Chemical Inc., Pomona, Calif., under the tradename JLS-APP101. This melamine coating has been found to enhance the flame retardancy properties of phosphorus-based compounds used in the fire retardant system of the invention. A preferred silicone coated, APP fire retardant component for use in the present invention is commercially available from JLS Fire retardants Chemical Inc., Pomona, Calif., under the tradename JLS-APP102.

The second fire retardant ingredient is an intumescent material. For purposes of the present invention, an intumescent fire retardant is a material that expands and forms a char layer as a barrier between the underlying material and surrounding environment. In one embodiment of the present invention, the fire retardant component is a material that expands as a result of a chemical reaction under heat. In another embodiment of the present invention, the fire retardant component is a material that expands as a result of a primarily physical reaction that occurs due to the configuration of components in the intumescent material.

In an embodiment of the present invention, preferred intumescent fire retardant components are graphite-containing materials, such as expandable graphite flake. Expandable graphite is commercially available from Nyacol Nano Technologies, Inc., Ashland, Mass., under the tradenarne NYACOL® NYAGRAPH and from Graftach, Cleveland, Ohio, under the tradename GRAFGUARD 220-80N. Mixtures of intumescent fire retardant components are specifically contemplated.

The third fire retardant ingredient is a brominated ingredient. Examples of such ingredients include, bromine powder, commercially available as Saytex 102E from Albermarle Corporation or FR-522 from Bromine Compounds Ltd.

In another embodiment, the brominated fire retardant ingredient is a brominated compound having an active hydrogen functionality that is co-reactive with the NCO of the first part. The active hydrogen of the brominated fire retardant ingredient preferably is provided by a hydroxy functionality or by an amine functionality, or a mixture thereof. Examples of such fire retardant ingredients include halogenated polyols, and in particular brominated polyols such as Firemaster® 520 fire retardant or PHT 4™ Diol fire retardant, both commercially available from Great Lakes Chemical Corporation, West Lafayette, Ind.; or Saytex 9170 or 9130 fire retardant from Albermarle Corp.

The fire retardant components are present in the fire retardant foam in an amount from about 10 to about 40% of the foam by weight. In a preferred embodiment, the fire retardant component is from about 15 to about 35% of the foam by weight.

Optionally, in addition to the above recited fire retardant ingredients, the foam may comprise one or more other fire retardant ingredients that operate by a mechanism different from intumescence. Examples of additional fire retardant components include the metallic oxides or hydroxides that contain water of hydration. Preferred metallic oxides or hydroxides include aluminum trihydride (ATH) and magnesium hydroxide, both of which provide fire retardancy from their inherent water content. Further examples of preferred additional fire retardant components include antimony trioxide and zinc borate.

For purposes of the present invention, a foam is a polymer matrix comprising bubbles and having a density of less than 25 pounds per cubic foot.

In an embodiment of the present invention, a high density foam is provided having a density of from about 4 to about 25 pounds per cubic foot, and preferably from about 6 to about 12 pounds per cubic foot. In another embodiment a medium density foam is provided having a density of from about 1.5 to about 4 pounds per cubic foot. In another embodiment a low density foam is provided having a density of from about 0.1 to about 1.5 pounds per cubic foot, and preferably from about 0.5 to about 1.5 pounds per cubic foot. In an embodiment of the present invention, the foam is provided in a density of about 2 to about 4 pounds per cubic foot, and preferably at a density of about 2.5 to 3 pounds per cubic foot. This density in particular finds usefulness as a spray for application as a roofing material.

In an embodiment of the present invention, a firm foam is provided having a Support Factor of greater than 2. In another embodiment of the present invention, a soft foam is provided having a Support Factor of less than 2. The Support Factor is determined by measuring the firmness (25% IFD) of the foam by compressing it 25 percent of its original height (e.g., a 4″ block of foam to 3″) and then measuring the firmness (25% IFD) when compressing the same foam sample 65 percent. The ratio of the 65 percent IFD divided by the 25 percent IFD is the foam's support factor. IFD is a measurement of foam firmness that is taken by measuring the force in pounds required to indent (compress) a foam sample a specified percentage of its height across and indenter foot with a surface area of 50 square inches. Normally, a four-inch thick foam sample is tested. See http://www.pfa.org/intouch/new_pdf/hr_IntouchV1.2.pdf

The foam layer preferably exhibits internal cohesive strength so that the foam does not tear apart by internal fracture during use. Preferably, the foam layer is formulated to exhibit an internal cohesive strength of at least about 4.5 lb/in as determined using peel strength evaluation ASTM D-5170, wherein the test is carried out using a one inch wide sample. More preferably, the foam layer has an internal cohesive strength of at least about 6 lb/in.

In another embodiment the fire retardant foam is either flexible, not flexible, or rigid. In an embodiment of the present invention, the fire retardant foam is flexible, which is defined herein as being bendable to an angle of 45° preferably at a force less than about 300 g*cm, more preferably at a force of about 100 to about 240 g*cm, and most preferably at a force of about 150 to about 200 g*cm as measured by the Cantilever Bending Test (ASTM D5732). This embodiment is particularly beneficial in providing a material that can be readily flexed for positioning in the desired location. Thus, flexible fire retardant bodies can advantageously be easier to install when used as liners in confined spaces, when delivered in roll form for application at a work site, or when the ultimate application requires conformation of the fire retardant foam to a structure, such as an I beam, architectural feature or the like.

In another embodiment, the fire retardant foam is rigid, which is defined herein as being unable to be bent to an angle of 45° without breaking the fire retardant foam. This embodiment advantageously provides stiff support to articles or structures to which the foam may be attached. In an aspect of this embodiment, the non-flexible fire retardant foam provides an article that is physically rigidly self-supported.

The foam is prepared as a polyurethane system from a first part and a second part that are reacted together as discussed above. The first part comprises at least one ingredient having NCO functionality, and preferably comprises one or more organic isocyanates having a functionality of two or higher. For example, organic diisocyanates, polyisocyanates, or mixtures thereof may be used successfully. The organic isocyanates may be aliphatic, cycloaliphatic, alicyclic, aromatic or aromatic aliphatic isocyanates.

Representative examples of optional isocyanate functional compounds include TDI, 4,4′-MDI, as well as other polyisocyanate materials listed or described in U.S. Pat. Nos. 6,262,217 (col. 3); 5,464,921 (col. 4); 5,288,797 (col. 4); 5,459,185 (col. 2); 5,603,798 (col. 3); 5,672,652 (col. 3); 5,852,103 (col. 3); 5,536,805 (col. 6 to col. 7); 4,426,488 (col. 4); 5,962,618 (col. 3 to col. 4); and 5,530,085 (col. 2). Others are also described in the Encyclopedia of Chemical Technology, Kirk-Othmer, 2d Ed., vol. 12, pp. 46-47 (1967). The various isocyanates suitable for the preparation of the foams of the invention are well known to those skilled in the art.

The second part comprises at least one ingredient having one or more active hydrogen functionalities that are co-reactive with the NCO, and preferably comprises one or more organic compounds having an active hydrogen functionality of two or higher. In an embodiment of the present invention, the active hydrogen of the second part is provided by ingredients having hydroxy functionalities. Preferred such compounds are polyols comprising more than one OH (hydroxyl) functional compounds, preferably comprising two or more hydroxyl groups, per molecule on average. The hydroxyl functional compounds may be aliphatic and/or aromatic. The hydroxyl functional compounds may be straight, cyclical, fused, and/or branched. In one embodiment, the preferred, hydroxyl functional compounds include at least one diol, at least one triol, and/or at least one tetrol. In other embodiments, the composition comprises polyols having 6-8 hydroxy functionalities. Compositions comprising higher numbers of active hydrogen functionalities are particularly preferred where foams having a high degree of rigidity is desired. Any of these polyol compounds may be monomeric, oligomeric, and/or polymeric as desired. If oligomeric and/or polymeric, the polyol(s) may be selected from one or more hydroxyl functional polyethers, polyesters , polyurethanes, polyacrylics, epoxy resins, polyamides, polyamines, polyureas, polysulfones, combinations of these, or the like. Polyether polyols are preferred as these are commercially available at relatively low cost and are hydrolytically stable.

In another embodiment of the present invention, the active hydrogens may be provided by amine functionalities. Preferred such compounds are polyamines comprising more than one NH or NH₂ (amine) functional compounds, preferably comprising two or more amine groups per molecule on average. The amine functional compounds may be aliphatic and/or aromatic. The amine functional compounds may be straight, cyclical, fused, and/or branched. In certain embodiments, the composition comprises polyamine compounds having 6-8 amine functionalities. Compositions comprising compounds having higher numbers of active hydrogen functionalities are particularly preferred where foams having a high degree of rigidity is desired. Any of these amine compounds may be monomeric, oligomeric, and/or polymeric as desired.

In one illustrative embodiment, the polyol component preferably includes at least one diol having a molecular weight in the range from about 500 to about 12,000, preferably from about 800 to about 8000; at least one triol preferably having a molecular weight in the range from 100 to about 12,000, more preferably 500 to 8000, and optionally a chain extender diol and/or diamine having a molecular weight up to about 500. In another embodiment, the polyol component preferably includes at least one polyol having 6-8 hydroxy functionalities and having a molecular weight in the range from about 100 to about 1000, preferably from about 300 to about 800. The amount of the diol(s), triol(s), other polyols and optional chain extender incorporated into the preferred polyol component may vary over a wide range with beneficial results. Generally, enough of the diol(s) are included to provide the desired degree of elastomeric characteristics, chain length, or other properties that are a function of the diol content; enough of the triol(s) to provide the desired degree of crosslinking; and enough of the chain extender to help build urethane/urea linkages as desired. As general guidelines, suitable formulations would include 10 to 100, preferably about 40 to 60 parts by weight of the diol(s), 0 to 50, preferably 5 to 25 parts by weight of the triol(s), and 0 to 15, preferably 2 to 10 parts by weight of optional chain extender(s) based upon 100 parts by weight of the polyol component. In other embodiments, the polyol component may contain only triol materials optionally in combination with 0 to 15 parts by weight of chain extender per 100 parts by weight of the polyol component. The various polyols suitable for the preparation of the foams of the invention are well known to those skilled in the art. These discussed ratios apply similarly when the active hydrogen is provided by amine functionalities.

In an embodiment of the present invention, the fire retardant foam is provided with a reinforcement material on one or more surfaces thereof, or optionally embedded within the fire retardant foam. Preferably the reinforcement material is made from a refractory material, such as alumina-borosilicate fibers available as Nextel brand fibers from 3M Company of St. Paul, Minn. and other thermally resistant materials such as reinforced carbon-carbon fibers, silica fibers, alumina fibers, ceramic fibers and combinations thereof. Such heat resistant reinforcement is beneficial in preserving the char structure generated when the fire retardant foam is exposed to heat and/or flame. This is helpful for optimal performance of the fire retardant foam, because the char structure is fragile and is easily displaced under windy or friction conditions. In the case of severe fire conditions, conventional intumescents may not provide adequate protection, because forces such as air flow will disrupt the char structure of the fire retardant foam when exposed to fire, thereby exposing surfaces to heat and flame. Thus, the embodiment comprising a reinforcement material in or on the fire retardant foam provides even more improved protection from fire. This reinforcement can be laminated into the foam, incorporated into the foam or otherwise compounded into the foam as is known by those skilled in the art.

In one embodiment, the reinforcement material is in the form of a continuous sheet material. In another embodiment, the reinforcement material is a non-continuous sheet material such as a perforated sheet or web material. Such a non-continuous sheet material is particularly desirably as an embedded reinforcement material, because it provides bridges of continuous contact of the fire retardant foam throughout the structure, thereby discouraging delamination or separation of the fire retardant foam matrix from the reinforcement material. In a particularly preferred embodiment, the reinforcement material is a woven or non-woven fabric made from natural or synthetic fibers.

The fire retardant foam may optionally comprise fillers, colorants, ultraviolet light absorbers, fungicides, bactericides, dyes, pigments, aluminum flakes, biocides, and other such additives suitable for incorporation into the fire retardant foam as will now be appreciated by the skilled artisan. Preferably, the foam layer comprises an antimicrobial agent. Such an agent is particularly desirable in a foam construction, which contains spaces and recesses that may be favorable for microbe growth.

Useful fillers include organic and/or inorganic filler. Exemplary inorganic fillers include sand, titania, clay, silica, fumed silica, combinations thereof, etc. Exemplary organic filler includes PVC, polystyrene, polypropylene, polyethylene, other olefinic fillers, combinations thereof, and the like. Preferred fillers include polyolefinic material such as polyethylene beads and/or polypropylene beads. Polyolefinic beads are lightweight and help provide cured compositions with high chemical resistance and high abrasion.

Suitable pigments include titanium dioxide, phthalocyanine blue, carbon black, basic carbonate white lead, zinc oxide, zinc sulfide, antimony oxide, zirconium oxide, lead sulfochromate, bismuth vanadate, bismuth molybdate, combinations thereof, etc.

In one embodiment, the foam layer is formed from an open-celled foam, that is a foam in which the various cells are in communication with each other and with the outer surface of the foam. Similar properties are achieved with a reticulated foam, that is a foam which has been treated to break down membranes which separated various cells.

The foam is formed by mixing the two parts discussed above in a manner so that a foam is formed. Preferably, the parts are mixed in presence of a blowing agent and water to form a foam in the desired density. The chemical blowing agent can be selected from any known blowing agent suitable for the respective polymer, for example, from aliphatic or cycloaliphatic compounds including hydrocarbons, ethers, lower alcohols, halogenated hydrocarbons, especially partially halogenated hydrocarbons, and “inorganic” blowing agents such as water, carbon dioxide, nitrous oxides such as NO, NO₂ and N₂O, nitrogen, ammonia, noble gases such as argon and air, or mixtures thereof. Inorganic blowing agents can also be produced in situ by adding chemical compounds to the composition which decompose and generate gas, such as known typically in the art, for example, azo-type compounds for the generation of N₂, ammonium compounds of the generation of NH₃ and mixtures of carbonates and acids for the generation of CO₂. Preferable in all cases are blowing agent compositions which have no ozone depletion potential, namely fluorinated alkanes, inorganic blowing agents, alcohols, hydrocarbons, ethers or combinations thereof. Particularly suitable, for example, for alkylene aromatic polymers and copolymers, or for olefinic polymers and copolymers, are blowing agent compositions composed primarily of carbon dioxide, and mixtures of carbon dioxide with water or ethanol or isopropanol or dimethyl ether or mixtures of two or more of these. Compositions based on (i) 1,1,1,2-tetrafluoroethane, (ii) 1,1,2,2-tetrafluoroethane, (iii) 1,1-difluoroethane, (iv) mixtures of two or more of these, or (v) mixtures of each compound or mixture with ethanol or isopropanol or dimethyl ether or water or carbon dioxide or mixtures of two or more of these are also particularly suitable in the practice of the present invention. Additionally, compositions based on dimethyl ether and mixtures of dimethyl ether with water or ethanol or isopropanol or carbon dioxide or mixtures of two or more of these are also suitable in the practice of the present invention. Other suitable blowing agents are hydrocarbons, such as propane, butane, pentane or mixtures thereof. Furthermore, mixtures of suitable hydrocarbons with dimethyl ether, carbon dioxide, and partially halogenated hydrocarbons are also suitable in the practice of the present invention.

The blowing agent is generally used in an amount of from about 0 to about 25 weight percent based on the total weight of the foamable composition. In a preferred embodiment, foams particularly desirable for application as a roofing treatment to be sprayed at the work site comprise about 3 to about 10 percent blowing agent.

In an embodiment of the present invention, the system is supplied to a work site where the foam is prepared and applied simultaneously to the surface to be protected from fire. This method is particularly advantageous, because the foam is formed in a manner that it closely conforms to the structure, and take advantage of all space available by filling in cavities and the like. Further, the amount of material to be used may be readily adapted to meet the needs of the conditions of use as observed by workers at the location.

In another embodiment of the present invention, the foam is prepared at a manufacturing location and transported in final foam form to the site of application. In this embodiment, various sizes and configurations of the foam product may be pre-prepared in advance of application to the desired point to be protected.

In another embodiment, the foam may be applied to a device or part at a manufacturing location, and the device or part then may be transported to the location of use or subsequent assembly.

In an embodiment of the present invention, the fire retardant foam can be provided with a metal layer (e.g. metal cladding) on one or more surfaces thereof. The fire retardant foam may optionally also be provided in the form of a plurality of layers, with the layers having the same or different chemical constitution. The fire retardant foam may be provided with an additional topcoat for protective or aesthetic purposes. Examples of topcoat compositions include urethane or silicone topcoat materials.

Additionally, the foam may be provided with a coating of adhesive on one or more sides to assist in lamination or attachment of the composite to another material. The adhesive may be a pressure sensitive adhesive or may be an activatable adhesive, such as a hot melt adhesive, light-cured adhesive, and the like.

The fire retardant foam is provided in a dimension suitable for use in protecting structures and/or articles. Thus, the fire retardant foam preferably has a thickness of at least about 3 mm in each dimension. In other embodiments, the fire retardant foam is provided with a greater thickness, i.e. having a thickness of from about 5 mm to about 30 mm, or alternatively from about 10 mm to about 80 mm in the smallest dimension.

In an embodiment of the present invention, the fire retardant foam is provided in a general shape suitable for use to contain girders or other support structures. In this embodiment, the foam has a thickness of at least about 3 mm, or about 3 mm to about 500 mm, about 5 mm to about 300 mm as discussed above. The lengths of the other dimensions are determined by the structure to be contained. Optionally, more than one piece can be used to contain the structure. Optionally, the fire retardant foam is provided in a non-planar configuration, i.e. having bends or corners. In the non-planar configuration, the dimensions are determined on a linear basis with the narrowest dimension being the thickness, and other dimensions determined as if bends or curves were removed to form a corresponding planar configuration.

In another embodiment of the present invention, the fire retardant foam may be provided in the size of standard sheet building materials, such as drywall or plywood. For example, the fire retardant foam may be provided in sizes of conventional gypsum drywall sizes (i.e. 4 ft×8 ft, 4 ft×9 ft, 4 ft×10 ft and 4 ft×12 ft, all in thicknesses of from about ⅛ inch, ¼ inch, ½ inch, or 1 inch in the US (with all combinations of the foregoing length, width and thickness measurements being specifically contemplated); and in similar size dimensions in other regional markets). Fire retardant bodies are specifically contemplated having a thickness of from about 3 mm to about 500 mm, width dimensions of from about 90 cm to about 160 cm, and length dimensions of from about 90 cm to about 400 cm. Fire retardant bodies of these sizes are particularly useful in wall, floor, ceiling or other construction applications.

Optionally, the fire retardant foam can be provided with irregular dimensions.

In one embodiment of the present invention, the fire retardant foam is affixed or placed adjacent to one side of an article, structure or space to be protected. In another embodiment, the fire retardant foam is affixed or placed adjacent to a plurality of sides of an article, structure or space to be protected. In another embodiment, the fire retardant foam is affixed or placed on all sides of an article, structure or space to be protected, thereby encapsulating the article, structure or space to be protected.

In another embodiment of the present invention, the fire retardant foam can be formed on or around a support structure or an article or material to be protected, thereby partially or completely encasing or encapsulating the support structure or an article or material to be protected. In a specifically contemplated embodiment, the fire retardant foam encases a wire material such as electrical wiring.

As noted above, the fire retardant foam provides superior protection against potentially devastating fire situations in building construction and in other environments where fire and excessive heat that would lead to fire is a concern.

### EXAMPLES

Representative embodiments of the present invention will now be described with reference to the following examples that illustrate the principles and practice of the present invention.

The fire retardant foam is formed from resins having the compositions as indicated below.

Materials:

| | |
|---|---|
| Poly G ® 30-340 | A polyol from Arch Chemicals, Inc. |
| Poly G ® 73-490 | a neutral, sorbitol-based polyol from Arch |
| | Chemicals, Inc. |
| Poly G ® 30-240 | A triol from Arch Chemicals, Inc. |
| Poly G ® 71-360 | A polyol from Arch Chemicals, Inc. |
| Poly G ® 72-465 | A polyol from Arch Chemicals, Inc. |
| DEG | di(ethylene glycol) |
| Terate ® 2541 | a polyester polyol available from available |
| | from Hoechst Celanese |
| Poly Q ® 40-800 | A polyol from Arch Chemicals, Inc. |
| Fyrol ™ PCF | Tris (1-chloro-2-propyl) phosphate (TCPP) |
| | fire retardant from Suprestra, Gallipolis |
| | Ferry, West Virginia |
| PHT 4 ™ Diol | a brominated aromatic polyol fire retardant |
| | available from Great Lakes Chemical |
| | Corporation, West Lafayette, IN |
| Pluracol ® 593 | polyether polyol available from BASF |
| HFC 134A | Blowing agent |
| APP 101 | melamine coated ammonium polyphosphate |
| | commercially available from JLS Flame |
| | Retardant Chemicals, Pomona, Calif. |
| Grafgard ™ 160-80N | expandable graphite fire retardant |
| | manufactured by UCAR |
| Firemaster ® 520 | fire retardant commercially available from |
| | Great Lakes Chemical Corporation, West |
| | Lafayette, IN |
| Tegostab ® B 7404; | Stabilizers commercially available from TH. |
| Tegostab ® B 8715; | Goldschmidt AG |
| Tegostab ® B 8404; | |
| Tegostab ® BF 2370 | |
| Dabco ® 33LV; | Catalysts commercially available from Air |
| Dabco ® BL19 | Products and Chemicals. |
| Lupranate ® M20S | a polymeric MDI commercially available |
| | from BASF |
| Polycat ® 43 | Catalyst commercially available from Air |
| | Products and Chemicals. |
| DMEA | Dimethylethanolamine catalyst |
| Jeffcat ® DPA | N-(3-dimethylaminopropyl)-N,N- |
| | diisopropanolamine (commercially available |
| | (from Huntsman Corp) |

### Testing of the Samples

The samples were tested for fire retardancy characteristics using Propane Torch (Bernzomatic TS 4000, Bernzomatic propane gas cylinder TX 9, both made by Newell Rubbermaid, Medina N.Y. 14103). The samples were positioned on horizontal surface and distance between the sample and nozzle of the torch was kept at 3 inches. The sample was exposed to the torch flame for 10-15 seconds and then the amount of flame penetration, type of smoke and time for the flame to self extinguish was observed.

### Fire Rating:

1—Burns completely
2—Slight resistance to fire but continuous burn
3—Flame extinguished after 3 to 5 seconds
4—Self extinguished immediately after flame is removed

TABLE 1
Low Density Foam (0.5 pounds per cubic feet)

| | Example 1 | | | | | |
|---|---|---|---|---|---|---|
| | (comparative) | Example 2 | Example 3 | Example 4 | Example 5 | Example 6 |
| | B side | B side | B side | B side | B side | B side |
| Poly G ® 30-340 | 30 | 30 | 30 | 30 | 30 | 30 |
| Poly G ® 85-36 | 31 | 31 | 23 | 31 | 15 | 23 |
| APP 101 | | 36 | | 72 | | 36 |
| Grafgard ™ 160-80N | | 14 | | 28 | | 14 |
| Firemaster ® 520 | | | 8 | | 16 | 8 |
| Tegostab ® BF 2370 | 0.7 | 0.7 | 0.7 | 0.7 | 0.7 | 0.7 |
| Dabco ® BL19 | 0.55 | 0.55 | 0.55 | 0.55 | 0.55 | 0.55 |
| Jeffcat ® DPA | 2.8 | 2.8 | 2.8 | 2.8 | 2.8 | 2.8 |
| Water | 34.95 | 34.95 | 34.95 | 34.95 | 34.95 | 34.95 |
| Total | 100 | 150 | 100 | 200 | 100 | 150 |
| Viscosity (cps) @ 75 F. | 220 | 1930 | 220 | 1930 | 220 | 2150 |
| | A side | A side | A side | A side | A side | A side |
| Lupranate ® M20S | 100 | 100 | 100 | 100 | 100 | 100 |
| Viscosity (cps) | 200 | 200 | 200 | 200 | 200 | 200 |
| Mixing ratio (by weight) A/B | 100/100 | 100/150 | 100/100 | 100/200 | 100/100 | 100/150 |
| Proceesing temp. (73-75 F.) | | | | | | |
| Cream Time (sec) | 15 | 40 | 10 | 45 | 15 | 25 |
| Gel Time (sec) | 40 | 190 | 40 | 200 | 55 | 170 |
| Tackfree Time (sec) | 55 | 7 minutes | 75 | 7 minutes | 80 | 250 |
| PCF | 1.19 | 2.22 | 2 | 2.3 | 1.4 | 2.32 |
| Fire Rating | 1 | 2 | 2 | 3 | 3 | 4 |

TABLE 2
High Density Foam (10 pounds per cubic feet)

| | Example 7 | | | | | |
|---|---|---|---|---|---|---|
| | (comparative) | Example 8 | Example 9 | Example 10 | Example 11 | Example 12 |
| | B side | B side | B side | B side | B side | B side |
| Poly G ® 73-490 | 60 | 60 | 52 | 60 | 44 | 52 |
| Poly G ® 30-240 | 25 | 25 | 25 | 25 | 25 | 25 |
| DEG | 2.6 | 2.6 | 2.6 | 2.6 | 2.6 | 2.6 |
| Poly G ® 71-360 | 10 | 10 | 10 | 10 | 10 | 10 |
| APP 101 | | 36 | | 72 | | 36 |
| Grafgard ™ 160-80N | | 14 | | 28 | | 14 |
| Firemaster ® 520 | | | 8 | | 16 | 8 |
| Tegostab ® B 7404 | 1.2 | 1.2 | 1.2 | 1.2 | 1.2 | 1.2 |
| Dabco ® 33LV | 1 | 1 | 1 | 1 | 1 | 1 |
| Water | 0.6 | 0.6 | 0.6 | 0.6 | 0.6 | 0.6 |
| Total | 100.4 | 150.4 | 100.4 | 200.4 | 100.4 | 150.4 |
| Viscosity (cps) @75 F. | 2690 | 9270 | 3070 | | | 9720 |
| | A side | A side | A side | A side | A side | A side |
| Lupranate ® M20S | 100 | 100 | 100 | 100 | 100 | 100 |
| Viscosity (cps) @ 75 F. | 200 | 200 | 200 | 200 | 200 | 200 |
| Mixing ratio (by weight) A/B | 100/100 | 100/150 | 100/100 | 100/200 | 100/100 | 100/150 |
| Proceesing temp. (73-75 F.) | | | | | | |
| Cream Time (sec) | 70 | 80 | 40 | 50 | 51 | 55 |
| Gel Time (sec) | 125 | 130 | 80 | 150 | 150 | 190 |
| Tackfree Time (sec) | 180 | 180 | 130 | 210 | 210 | 300 |
| PCF | 9.16 | 10.39 | 10.6 | 10.6 | 10.6 | 10.8 |
| Fire Rating | 1 | 2 | 2 | 3 | 3 | 4 |

TABLE 3
Flexible Foam (5 PCF)

| | Example 13 | | | | | |
|---|---|---|---|---|---|---|
| | (comparative) | Example 14 | Example 15 | Example 16 | Example 17 | Example 18 |
| | B side | B side | B side | B side | B side | B side |
| Pluracol ® P 380 | 77.5 | 82.55 | 74.55 | 82.55 | 66.5 | 74.55 |
| P-973 | 10 | | | | | |
| Poly G ® 92-27 | | 10 | 10 | 10 | 10 | 10 |
| 1:4 BDO | 3.65 | 3.65 | 3.65 | 3.65 | 3.65 | 3.65 |
| Pluracol ® 593 | 5 | | | | | |
| water | 1.9 | 1.9 | 1.9 | 1.9 | 1.9 | 1.9 |
| APP 101 | | 36 | | 72 | | 36 |
| Grafgard ™ 160-80N | | 14 | | 28 | | 14 |
| Firemaster ® 520 | | | 8 | | 16 | 8 |
| Tegostab ® B 8715 | 0.8 | 0.8 | 0.8 | 0.8 | 0.8 | 0.8 |
| Dabco ® 33LV | 0.65 | 0.65 | 0.65 | 0.65 | 0.65 | 0.65 |
| DMEA | 0.45 | 0.45 | 0.45 | 0.45 | 0.45 | 0.45 |
| Total | 99.95 | 150 | 100 | 200 | 99.95 | 150 |
| Viscosity (cps) @75 F. | | | | | | |
| | A side | A side | A side | A side | A side | A side |
| Prepolymer (15-18% NCO) | 30 | 30 | 30 | 30 | 30 | 30 |
| Viscosity (cps) @ 75 F. | 750 | 750 | 750 | 750 | 750 | 750 |
| Mixing ratio (by weight) A/B | 30/50 | 30/75 | 30/50 | 30/100 | 30/50 | 30/75 |
| Proceesing temp. (73-75 F.) | | | | | | |
| Cream Time (sec) | 70 | 80 | 40 | 80 | 40 | 55 |
| Gel Time (sec) | 125 | 130 | 80 | 130 | 80 | 190 |
| Tackfree Time (sec) | 180 | 180 | 130 | 180 | 130 | 300 |
| PCF | 9.16 | 10.39 | 10.6 | 10.39 | 10.6 | 10.8 |
| Fire Rating | 1 | 2 | 2 | 3 | 3 | 4 |

TABLE 4
Spray Foam 3.00 PCF

| | Example 19 | | | | | |
|---|---|---|---|---|---|---|
| | (comparative) | Example 20 | Example 21 | Example 22 | Example 23 | Example 24 |
| | B side | B side | B side | B side | B side | B side |
| Poly G ® 72-465 | 20.95 | 28.95 | 20.95 | 28.95 | 12.95 | 20.95 |
| Terate ® 2541 | 43.5 | 42.4 | 42.4 | 42.4 | 42.4 | 42.4 |
| Poly Q ® 40-800 | 5 | 5 | 5 | 5 | 5 | 5 |
| Fyrol ™ PCF | 8 | 8 | 8 | 8 | 8 | 8 |
| PHT 4 ™ Diol | 6.9 | | | | | |
| HFC 134A | 10 | 10 | 10 | 10 | 10 | 10 |
| Water | 1.1 | 1.1 | 1.1 | 1.1 | 1.1 | 1.1 |
| APP 101 | | 36 | | 72 | | 36 |
| Grafgard ™ 160-80N | | 14 | | 28 | | 14 |
| Firemaster ® 520 | | 0 | 8 | 0 | 16 | 8 |
| Polycat ® 43 | 2 | 2 | 2 | 2 | 2 | 2 |
| DMEA | 2 | 2 | 2 | 2 | 2 | 2 |
| 24% Lead Catalyst | 0.25 | 0.25 | 0.25 | 0.25 | 0.25 | 0.25 |
| Tegostab ® B 8404 | 0.3 | 0.3 | 0.3 | 0.3 | 0.3 | 0.3 |
| Total | 100 | 150 | 100 | 200 | 100 | 150 |
| Viscosity (cps) @75 F. | | | | | | |
| | A side | A side | A side | A side | A side | A side |
| Lupranate ® M20S | 100 | 100 | 100 | 100 | 100 | 100 |
| Viscosity (cps) @ 75 F. | 220 | 220 | 220 | 220 | 220 | 220 |
| Mixing ratio (by weight) A/B | 50/50 | 50/75 | 50/75 | 50/100 | 50/75 | 50/75 |
| Proceesing temp. (73-90 F.) | | | | | | |
| Cream Time (sec) | 2-3 | 2-3 | 2-3 | 2-3 | 2-3 | 2-3 |
| Gel Time (sec) | 7-8 | 8-9 | 7-8 | 9-10 | 8-9 | 8-9 |
| Tackfree Time (sec) | 12-14 | 13-15 | 12-14 | 15-16 | 13-15 | 13-15 |
| PCF | 3.12 | 3.48 | 3.15 | 3.61 | 3.32 | 3.44 |
| Fire Rating | 1 | 2 | 2 | 3 | 3 | 4 |

TABLE 5
Examples with Bromine powder in foam formulation.

| Low Density Foam (0.5 pounds per cubic feet) | | | High Density Foam (10 pounds per cubic feet) | | |
|---|---|---|---|---|---|
| | Example 25 | Example 26 | | Example 27 | Example 28 |
| | B side | B side | | B side | B side |
| Poly G ® 30-340 | 30 | 30 | Poly G ® 73-490 | 55.6 | 55.6 |
| Poly G ® 85-36 | 27 | 27 | Poly G ® 30-240 | 25 | 25 |
| APP 101 | | 36 | DEG | 2.6 | 2.6 |
| Grafgard ™ 160-80N | | 14 | Poly G ® 71-360 | 10 | 10 |
| Saytex 102E | 4 | 4 | APP 101 | | 36 |
| Tegostab ® BF 2370 | 0.7 | 0.7 | Grafgard ™ 160-80N | | 14 |
| Dabco ® BL19 | 0.55 | 0.55 | Saytex 102E | 4 | 4 |
| Jeffcat DPA | 2.8 | 2.8 | Tegostab ® B 7404 | 1.2 | 1.2 |
| Water | 34.95 | 34.95 | Dabco ® 33LV | 1 | 1 |
| | | | Water | 0.6 | 0.6 |
| Total | 100 | 150 | Total | 100 | 150 |
| Viscosity (cps) @ 75 F. | 250 | 2540 | Viscosity (cps) @75 F. | 2800 | 11700 |
| | A side | A side | | A side | A side |
| Lupranate ® M20S | 100 | 100 | Lupranate ® M20S | 100 | 100 |
| Viscosity (cps) | 200 | 200 | Viscosity (cps) @ 75 F. | 200 | 200 |
| Mixing ratio (by weight) A/B | 100/100 | 100/150 | Mixing ratio (by weight) A/B | 100/100 | 100/150 |
| Processing temp. (73-75 F.) | | | Processing temp. 3-75 F.) | | |
| Cream Time (sec) | 30 | 51 | Cream Time (sec) | 28 | 62 |
| Gel Time (sec) | 76 | 190 | Gel Time (sec) | 110 | 132 |
| Tackfree Time (sec) | 90 | 7 minutes | Tackfree Time (sec) | 180 | 200 |
| PCF | 1.81 | 1.85 | PCF | 12.05 | 12.54 |
| Fire Rating | 2 | 4 | Fire Rating | 2 | 4 |

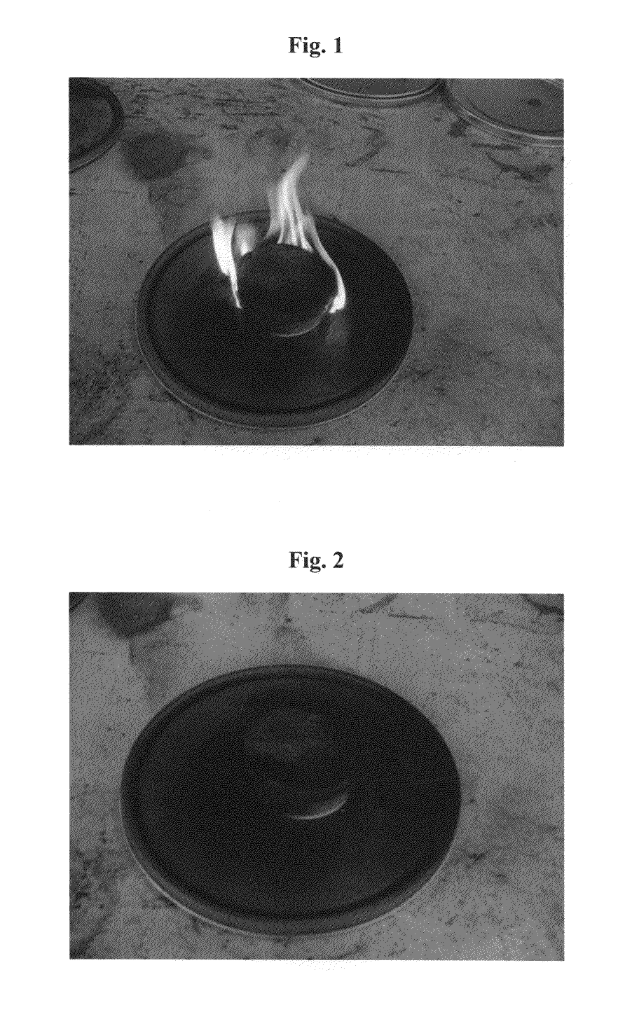

The fire retardancy testing for high density foam Examples 7-12 is shown at FIGS. 1-12.

FIGS. 1 and 2 show burning of the sample during the test, and the result after burning of Example 7, which does not contain fire retardant. As can be seen in FIG. 2, the sample burns completely.

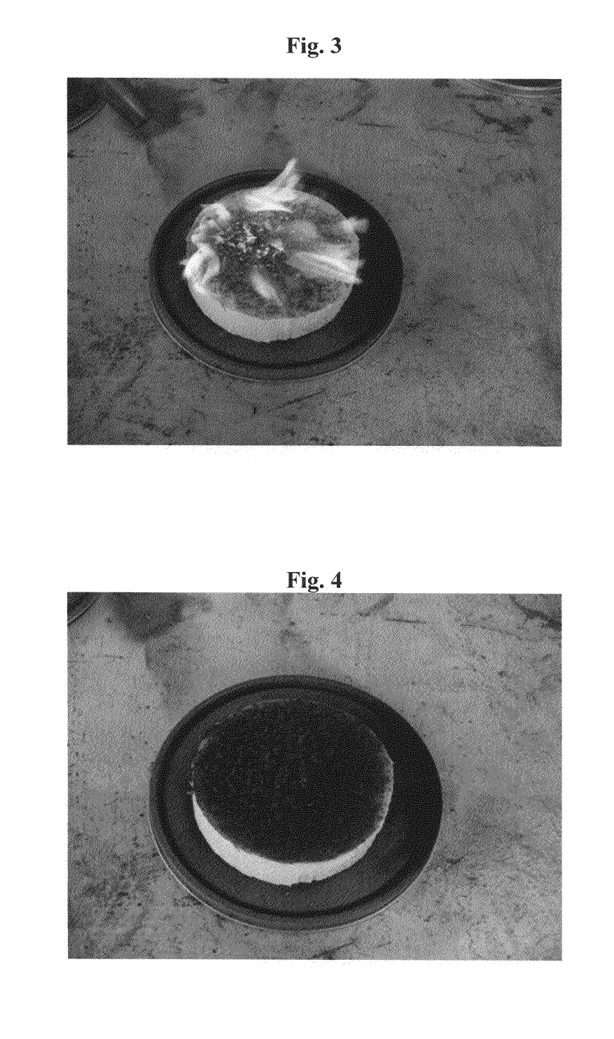

FIGS. 3 and 4 show burning of the sample during the test, and the result after burning of Example 8. This Example contains APP 101 and Grafgard™ 160-80N as fire retardants. As can be seen in FIG. 4, some fire resistance can be observed.

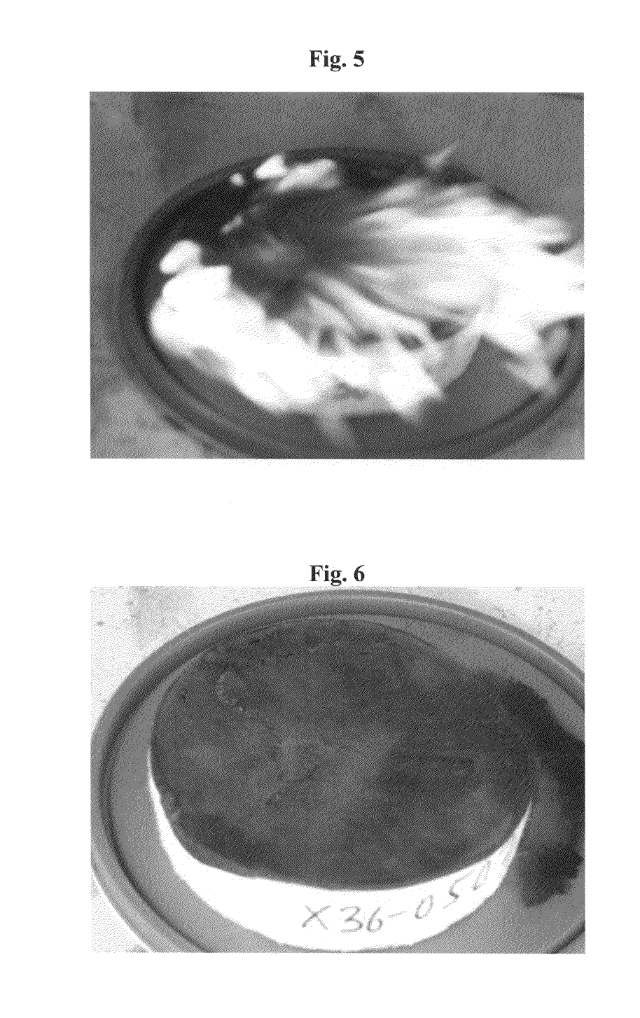

FIGS. 5 and 6 show burning of the sample during the test, and the result after burning of Example 9. This Example contains Firemaster® 520 as the fire retardant. As can be seen in FIG. 6, some fire resistance can be observed.

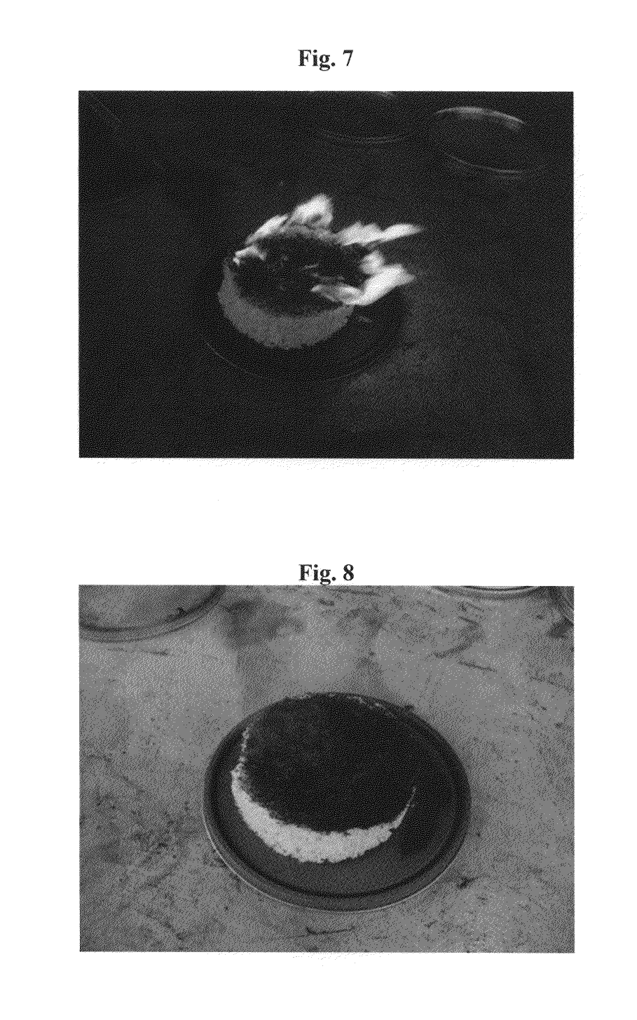

FIGS. 7 and 8 show burning of the sample during the test, and the result after burning of Example 10. This Example contains APP 101 and Grafgard™ 160-80N as fire retardants in higher amounts than provided in Example 8. It was observed that the flame self-extinguishes after burning for 3-5 seconds, resulting in much less damage to the foam.

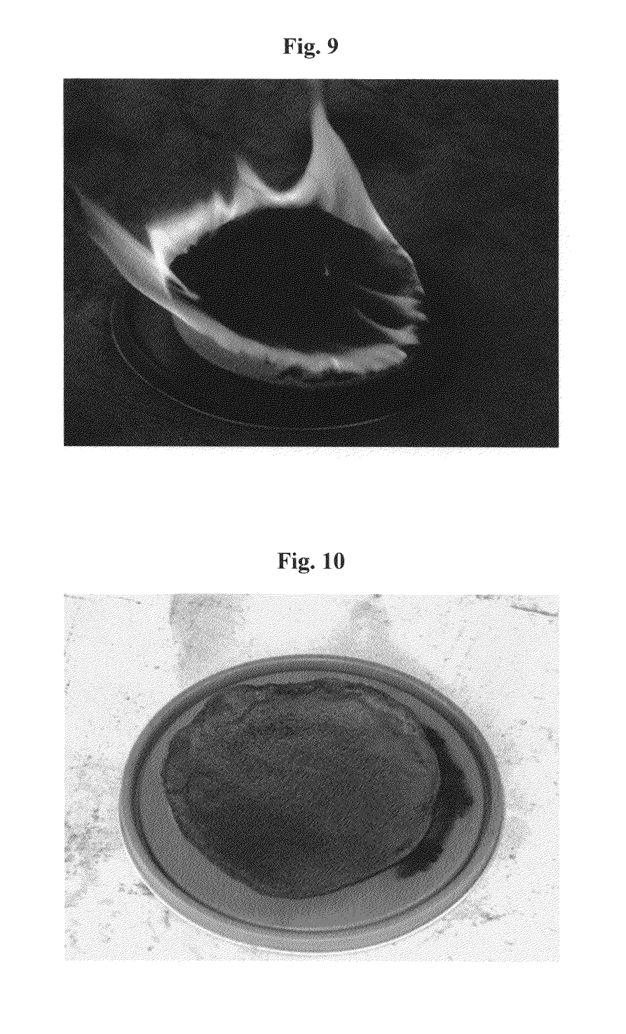

FIGS. 9 and 10 show burning of the sample during the test, and the result after burning of Example 11. This Example contains Firemaster® 520 as the fire retardant in a higher amount than provided in Example 9. It was observed that the flame self-extinguishes after burning for 3-5 seconds, resulting in much less damage to the foam.

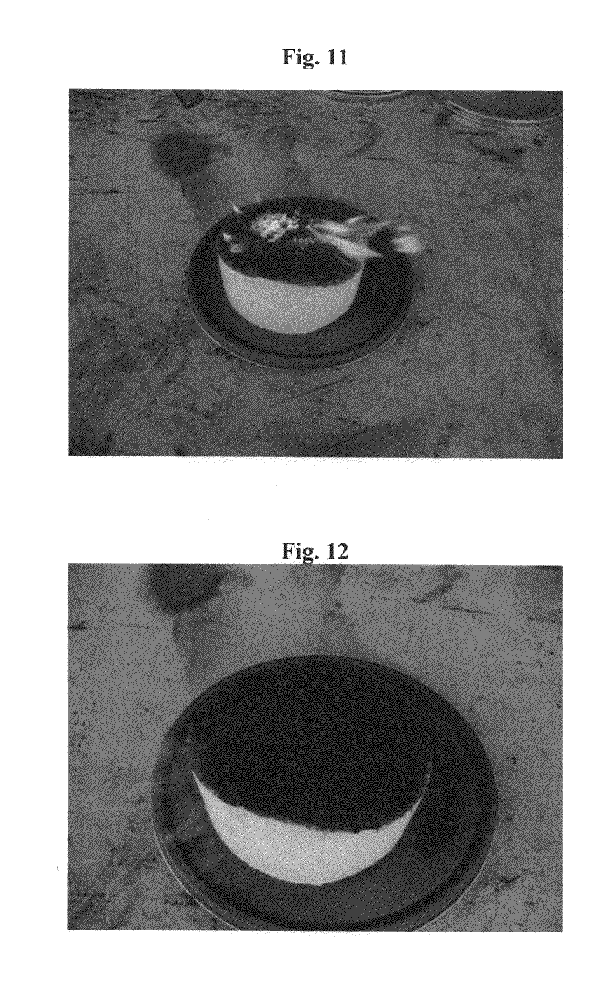

FIGS. 11 and 12 show burning of the sample during the test, and the result after burning of Example 12. This Example contains APP 101, Grafgard™ 160-80N, and Firemaster® 520 as the fire retardants. It was observed that the flame self-extinguishes after the torch is removed resulting in significantly less damage to the foam.

The observations of fire retardancy behavior of high density foam with the indicated fire retardant composition are consistent with those of the other kinds of foam samples, i.e. Low density foam (Examples #1 thru 6), Flexible foam (Examples #13 thru 18), and Spray foam (Examples #19 thru 24).

All patents, patent applications (including provisional applications), and publications cited herein are incorporated by reference as if individually incorporated for all purposes. Unless otherwise indicated, all parts and percentages are by weight and all molecular weights are weight average molecular weights. The foregoing detailed description has been given for clarity of understanding only. No unnecessary limitations are to be understood therefrom. The invention is not limited to the exact details shown and described, for variations obvious to one skilled in the art will be included within the invention defined by the claims.

What is claimed is:

1. A fire retardant foam system comprising:
a. a first part comprising at least one ingredient having NCO functionality; and
b. a second part comprising at least one ingredient having an active hydrogen functionality that is co-reactive with the NCO;
wherein the foam system comprises at least three fire retardant ingredients that are:
i) a first fire retardant ingredient that is a phosphorus-based compound,
ii) a second fire retardant ingredient that is an intumescent material; and
iii) a third fire retardant ingredient that is a brominated fire retardant ingredient;
wherein the first part and the second part are formulated so that when the parts are mixed together they form a cured foam.

2. The fire retardant foam system of claim 1, wherein the first fire retardant ingredient is a phosphate-based compound.

3. The fire retardant foam system of claim 1, wherein the active hydrogen of the second part is provided by a hydroxy functionality.

4. The fire retardant foam system of claim 1, wherein the active hydrogen of the second part is provided by an amine functionality.

5. The fire retardant foam system of claim 1, wherein the brominated fire retardant ingredient is a brominated compound having an active hydrogen functionality that is co-reactive with the NCO of the first part.

6. The fire retardant foam system of claim 1, wherein the brominated fire retardant ingredient is a brominated compound having a functionality that is co-reactive with the active hydrogen of the second part.

7. The fire retardant foam system of claim 1, wherein
i) the first fire retardant ingredient that is a phosphate-based compound that is APP,
ii) the second fire retardant ingredient that is an intumescent material that is expandable graphite; and
iii) the third fire retardant ingredient that is a brominated fire retardant ingredient having a hydroxy functionality.

8. The fire retardant foam system of claim 1, wherein the foam has a density of from about 4 to about 25 pounds per cubic foot.

9. The fire retardant foam system of claim 1, wherein the foam has a density of from about 1.5 to about 4 pounds per cubic foot.

10. The fire retardant foam system of claim 1, wherein the foam has a density of from about 0.1 to about 1.5 pounds per cubic foot.

11. The fire retardant foam system of claim 1, wherein the foam is bendable to an angle of 45° at a force less than about 300 g*cm, as measured by the Cantilever Bending Test (ASTM D5732).

12. The fire retardant foam system of claim 1, wherein the foam is bendable to an angle of 45° at a force greater than about 300 g*cm, as measured by the Cantilever Bending Test (ASTM D5732).

13. The fire retardant foam system of claim 1, wherein the foam is unable to be bent to an angle of 45° without breaking the fire retardant foam.

14. A method of preparing a fire retardant foam comprising
a. providing a fire retardant foam system of claim 1, and
b. mixing the first part and the second part together so that they form a cured foam.

15. A fire retardant foam made by the process of claim 14.

16. A method for protecting an article, structure or space from fire damage, comprising
a) applying the foam of claim 15 as fire barrier adjacent or affixed to at least one side of an article, structure or space to be protected.
